(19) United States
(12) Patent Application Publication
(10) Pub. No.: US 2024/0132644 A1
(43) Pub. Date: Apr. 25, 2024

(54) MACROMONOMER, METHOD FOR OBTAINING SAME AND COPOLYMER CONTAINING SAME

(71) Applicant: SNF Group, Andrezieux Boutheon (FR)

(72) Inventors: Cédrick FAVERO, Andrezieux Boutheon (FR); Olivier BRAUN, Andrezieux Boutheon (FR); Emmanuelle READ, Andrezieux Boutheon (FR); Thierry LEBLANC, Andrezieux Boutheon (FR); Johann KIEFFER, Andrezieux Boutheon (FR)

(73) Assignee: SNF Group, Andrezieux Boutheon (FR)

(21) Appl. No.: 18/257,631

(22) PCT Filed: Dec. 13, 2021
(86) PCT No.: PCT/FR2021/052310

§ 371 Date: Jun. 15, 2023

(30) Foreign Application Priority Data
Dec. 17, 2020 (FR) FR2013535

(51) Int. Cl. C08F 220/54; C08F 265/10

(52) U.S. Cl. CPC C08F 220/54; C08F 265/10; C08F 2810/30

(57) ABSTRACT

This invention relates to an LCST macromonomer, obtained by a reaction between an LCST telomere and a compound containing a carbon-carbon double bond. The invention also relates to an LCST copolymer, obtained by a reaction between the LCST macromonomer and a water-soluble monomer.

### TECHNICAL FIELD OF THE INVENTION

The invention relates to the field of LCST macromonomers, a method for obtaining said macromonomer and the copolymers comprising said macromonomers.

### PRIOR ART

Water-soluble polymers with a thickening effect are used in many fields such as cosmetics, detergents, printing inks, dispersion paints, textiles, civil engineering, construction, and also in enhanced oil and gas recovery.

There are many different chemistries, known to those skilled in the art, of polymers that may be used as thickeners. An important class of polymers is called heat-sensitive. These polymers have pendant or end groups that have an LCST (lower critical demixing temperature). These LCST groups correspond to groups whose solubility in water for a given concentration is modified beyond a certain temperature and as a function of salinity.

In addition, during its use it must be ensured that the aqueous solution comprising the polymer does not comprise gel particles. In fact, even small particles of gel, the dimensions of which are on the order of a micrometer, may strongly affect the thickening performance during use.

The subject-matter of this invention is therefore to provide heat-sensitive copolymers, i.e., copolymers obtained by polymerization of one or more LCST macromonomers.

Furthermore, the invention aims to provide such copolymers whose effect as a thickening agent is at least equal to that of the polymers of the prior art and which, during their uses, are free of gel particles.

### DISCLOSURE OF THE INVENTION

The LCST Macromonomer

The invention relates to a novel LCST macromonomer of formula (I):

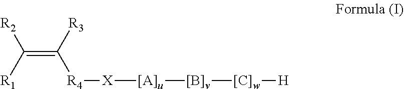

wherein,
R₁, R2, and R₃ are independently hydrogen, methyl group, C(═O)—YR₅, CH₂C(═O)—YR₅, C(═O)—O⁻M⁺, or CH₂C(═O)—O⁻M⁺;
Y is NR′₅ or O;
R₅, R′₅ are independently a hydrogen atom or a carbon radical, saturated or unsaturated, optionally aromatic, linear, branched or cyclic, comprising 1 to 30 carbon atoms, comprising from 0 to 4 heteroatoms chosen from the group comprising O, N, and S;
R₄ is CH₂, C(═O), C₆H₄—C(CH₃)₂—NH—C(═O)— where C₆H₄ is a disubstituted benzene ring, C(═O)O—CH₂—CH(OH)—CH₂, or CH₂—O—CH₂—CH(OH)—CH₂;
M⁺ is an alkali metal cation, an alkaline earth metal cation, or an ammonium; the symbol M⁺ includes the case where the metal cation carries two positive charges when it is an alkaline earth metal cation;
X is chosen from the groups of formula Z—R₈—S wherein Z is O, NH, or O—C(═O), O—C(═O)—CH(NH₂) and R₈ is a CₙH₂n group with integer n being between 1 and 30, preferably between 1 and 18;
monomer A is of formula (II):

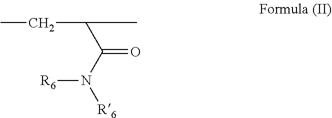

monomer B is of formula (III):

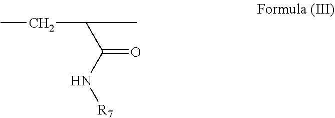

wherein,
R₆, R₆′, and R₇ are independently a carbon radical, saturated, or unsaturated, optionally aromatic, linear, branched, or cyclic, comprising 1 to 30 carbon atoms, comprising from 0 to 4 heteroatoms chosen from the group comprising O, N, and S,
monomer C is at least one anionic monomer and/or at least one cationic monomer and/or at least one nonionic monomer,
u, v, and w are the molar proportions of the monomers, such that u+v+w=100 mol %, and
   u is between 50 and 99 mol %, preferably between 60 and 98 mol %, more preferably between 70 and 95 mol % relative to all of the molar proportions of monomers A, B, and C,
   v is between 1 and 20 mol %, preferably between 1 and 15 mol %, more preferably between 2 and 10 mol % with respect to the total molar proportions of monomers A, B, and C,
   w is between 0 and 30 mol %, preferably between 1 and 25 mol %, more preferably between 3 and 20 mol % with respect to the total molar proportions of monomers A, B, and C.

Concerning the formula (I) of the LCST macromonomer described above, and repeated in the remainder of this text, when R₄ is C₆H₄—C(CH₃)₂—NH—C(═O)—, the C₆H₄ benzene ring is preferably substituted in the para position.

The semi-developed formula (II) of monomer A described above, and repeated in the rest of this text, is as follows: —CH₂—CH[C(═O)—NR₆R′₆]—.

The semi-developed formula (III) of monomer B described above, and repeated in the rest of this text, is as follows: —CH₂—CH[C(═O)—NHR₇]—.

In this text, the term “mol %” represents the molar percentage of the chemical species considered, also denoted “molar %” or “mol %”.

The macromonomer may have an alternating, block, or statistical monomer distribution. Preferably, the distribution of the monomers is statistical.

Preferably, the macromonomer is of formula (I) wherein:
R₁, R₂, and R₃ are independently a hydrogen atom, or a methyl group,
R₄ is CH₂, C(═O), C₆H₄—C(CH₃)₂—NH—C(═O)— where C₆H₄ is a disubstituted benzene ring, C(═O)O—CH₂—CH(OH)—CH₂, or CH₂—O—CH₂—CH(OH)—CH₂;
X is of the ZR formula Z—R8-S wherein Z is O or NH and R8 is a CₙH₂ₙ group with n being an integer between 1 and 30;
monomer C is at least one anionic monomer;
R₆ and R₆′ are independently a carbon radical, saturated or unsaturated comprising between 2 and 10 carbons;
R₇ is a carbon radical, saturated or unsaturated, linear or branched comprising between 3 and 10 carbon atoms.

Preferably, monomer C is at least one anionic monomer chosen from acrylic acid, methacrylic acid, itaconic acid, crotonic acid, maleic acid, fumaric a 2-methylpropane sulfonic acid, vinyl sulfonic acid, vinylphosphonic acid, allyl sulfonic acid, allyl phosphonic acid, styrene sulfonic acid; and the water-soluble salts of these monomers such as their alkali metal, alkaline earth metal, or ammonium salts.

Preferably, the macromonomer is of formula (I) wherein:
R₁, R₂, and R₃ are independently a hydrogen atom, a methyl group;
R₄ is CH₂, C(═O), C₆H₄—C(CH₃)₂—NH—C(═O)— where C₆H₄ is a disubstituted benzene ring, C(═O)O—CH₂—CH(OH)—CH₂, CH₂—O—CH₂—CH(OH)—CH₂;
X is of formula Z—R₈—S wherein Z is O, NH, and R₈ is a CₙH₂ₙ group with n being an integer between 1 and 18;
monomer C is 2-acrylamido-2-methylpropane sulfonic acid and/or its alkali metal, alkaline-earth metal, or ammonium salt;
R₆ and R₆′ are the —CH₂—CH₃ group;
R₇ is the —C(CH₃)₃ group.

According to the general knowledge of those skilled in the art, the LCST groups correspond to groups whose solubility in water for a given concentration is modified above a certain temperature and as a function of the salinity. These are groups exhibiting a transition temperature by heating defining their lack of affinity with the solvent medium. Lack of affinity with the solvent results in opacification or loss of transparency.

The minimum transition temperature is called “LCST” (acronym for “Lower Critical Solution Temperature”). For each LCST group concentration, a heating transition temperature is observed. It is greater than the LCST, which is the minimum point of the curve. Below this temperature, the macromonomer is soluble in water, above this temperature the macromonomer loses its solubility in water.

Usually, the measurement of the LCST may be done visually: the temperature at which the lack of affinity with the solvent appears, i.e., the cloud point, is determined. The cloud point corresponds to the opacification of the solution or loss of transparency.

The LCST may also be determined according to the phase transition type, for example by DSC (acronym for “Differential Scanning Calorimetry”), by measuring transmittance or viscosity.

A person skilled in the art knows the various techniques for determining the LCST and knows how to choose the technique most suited to his situation.

Preferably, the LCST is found by determining the cloud point by transmittance according to the following protocol.

The transition temperature is measured for an LCST compound for a solution having a mass concentration in deionized water of 1% by weight of said compound. The cloud point corresponds to the temperature at which the solution has a transmittance equal to 85% of light rays having a wavelength between 400 and 800 nm.

In other words, the temperature at which the solution has a transmittance equal to 85% corresponds to the compound's minimum LCST transition temperature, in this case from the LCST macromonomer.

Generally speaking, a transparent composition has a maximum light transmittance value at any wavelength between 400 nm and 800 nm through a 1 cm thick sample of at least 85%, preferably at least 90%. This is why the cloud point corresponds to a transmittance of 85%.

According to the invention, the LCST macromonomer has a molecular weight preferentially comprised between 500 g/mol and 50000 g/mol, more preferentially comprised between 1000 g/mol and 25000 g/mol, even more preferentially comprised between 5000 g/mol and 10000 g/mol. The molecular weight is understood as weight average molecular weight.

Preparation of the LCST Macromonomer

According to another aspect, the invention also relates to the preparation of the LCST macromonomer as described above.

In general, the LCST macromonomer is obtained by synthesizing an LCST telomere having a functional end, and then by grafting an ethylenic group onto the latter.

Preparing the LCST macromonomer as described above comprises:
preparing at least one LCST telomer from at least one monomer A of formula (II), from at least one monomer B of formula (III), at least one monomer C and a telogenic agent,
preparing a macromonomer by reaction between the LCST telomere obtained and a compound containing a carbon-carbon double bond, carbon-carbon double bond being still present in the LCST macromonomer obtained after said reaction.

According to the invention, in a first step, the telomeres are synthesized by telomerization using a telogenic agent. Telomerization favors the synthesis of low molecular weight LCST oligomers (called telomeres).

For the purpose of simplifying this text, “monomers A, B, and C” refer both to the monomers whose telomerization leads to the LCST telomere, and to the constituent monomers of the telomere and of the macromonomer obtained by polymerization of the telomere with a compound containing a carbon-carbon double bond. It will, however, be understood that within the telomere and the macromonomer, monomers A, B, and C are no longer capable of reacting by polymerization, since they have already polymerized with each other, and are therefore interconnected. Within the telomer and macromonomer, the A, B, and C monomers may also be referred to as “patterns” or “monomer units.”

The term “telomerization” is understood to mean an oligomerization or a polymerization by chain reaction, conducted in the presence of an excess of a transfer agent, and such that the terminal groups are fragments of the transfer agent. The oligomer or the polymer obtained is called “telomere.” According to the invention, the telogenic agent is chosen from the compounds of formula Z′—R₈—SH wherein Z′ is OH, NH₂, HO—C(═O)—CH(NH₂) or C(═O)—OH, R₈ is a CₙH₂ₙ group with n being an integer between 1 and 30.

Preferably, the telogenic agent is chosen from compounds of formula Z′—R₈—SH wherein Z′ is OH or NH₂ and R₈ is a CₙH₂ₙ group with n being an integer between 1 and 30.

Preferably, the telogenic agent is chosen from compounds of formula Z′—R₁₀—SH wherein Z′ is OH or NH₂ and R₁₀ is a CₙH₂ₙ group with n being an integer between 1 and 18.

According to the invention, the LCST telomere is of formula (IV):

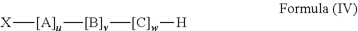

wherein,
X is chosen from the groups of formula Z′—R₈—S wherein Z′ is OH, NH₂, HO—C(═O)—CH(NH₂) or C(═O)—OH, and R₈ is a CₙH₂ₙ group with n being an integer between 1 and 30,
monomer A has formula (II):

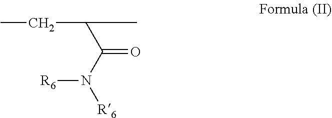

monomer B is of formula (III):

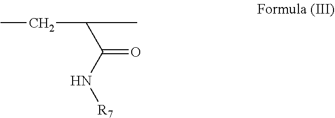

wherein,
R₆, R₆′, and R₇ are independently a carbon radical, saturated or unsaturated, optionally aromatic, linear, branched, or cyclic, comprising 1 to 30 carbon atoms, comprising from 0 to 4 heteroatoms chosen from the group comprising 0, N, and S,
monomer C is at least one anionic monomer and/or at least one cationic monomer and/or at least one nonionic monomer,
u, v, and w are the molar proportions of the monomers, such that u+v+w=100 mol %, and
   u is between 50 and 99 mol %, preferably between 60 and 98 mol %, more preferably between 70 and 95 mol % relative to all of the molar proportions of monomers A, B, and C,
   v is between 1 and 20 mol %, preferably between 1 and 15 mol %, more preferably between 2 and 10 mol % with respect to the total molar proportions of monomers A, B, and C,
   w is between 0 and 30 mol %, preferably between 1 and 25 mol %, more preferably between 3 and 20 mol % with respect to the total molar proportions of monomers A, B, and C.

The macromonomer may have an alternating, block, or statistical monomer distribution. Preferably, the distribution of the monomers is statistical.

Preferably, the macromonomer is of formula (I) wherein monomer C is an anionic monomer. According to a preferred embodiment, the telomere is of formula (IV) wherein:
X is of formula Z′—R₈—S wherein Z′ is OH or NH₂ and R₈ is a Cₙ H₂ₙ group with integer n being between 1 and 30,
monomer C comprises at least one anionic monomer chosen from acrylic acid; methacrylic acid; itaconic acid; crotonic acid; maleic acid; fumaric acid, 2-acrylamido 2-methylpropanesulfonic acid, vinylsulfonic acid, vinylphosphonic acid, allyl sulfonic acid, allyl phosphonic acid, styrene sulfonic acid; and the water-soluble salts of these monomers such as their alkali metal, alkaline-earth metal, or ammonium salts,
R₆ and R₆′ are independently a carbon radical, saturated or unsaturated comprising between 2 and 10 atoms of carbon,
R₇ is a carbon radical, saturated or unsaturated, linear or branched comprising between 3 and 10 carbon atoms.

According to another preferred embodiment, the telomere is of formula (V):

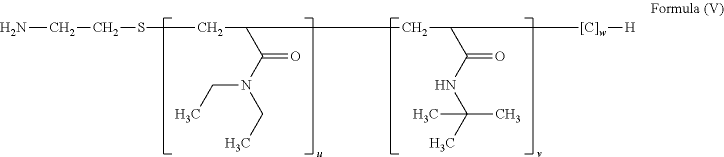

wherein,
the distribution of the three monomers is random,
monomer C is 2-acrylamido 2-methylpropane sulfonic acid and/or its alkali metal salt, alkaline earth, or ammonium,
u, v, and w are the molar proportions of the three monomers such that u+v+w=100 mol %, and
   u is between 50 and 99 mol %, preferably between 60 and 98 mol %, more preferably between 70 and 95 mol % relative to all of the molar proportions of monomers A, B, and C,
   v is between 1 and 20 mol %, preferably between 1 and 15 mol %, more preferably between 2 and 10 mol % with respect to the total molar proportions of the three monomers,
   w is between 0 and 30 mol %, preferably between 1 and 25 mol %, more preferably between 3 and 20 mol % with respect to the total molar proportions of the three monomers.

According to the invention, in a second step, once the LCST telomeres have been formed, a vinyl double bond is introduced at the end of the chain so that the said LCST telomeres serve as LCST macromonomers which may in turn be polymerized.

According to the invention, the end of the chain is functionalized via a compound containing a carbon-carbon double bond. This compound containing a carbon-carbon double bond is preferably chosen from acryloyl chloride, acrylic acid, methacryloyl chloride, methacrylic acid, maleic anhydride, methacrylic anhydride, unsaturated aliphatic isocyanates, allyl chloride, allyl bromide, glycidyl acrylate, and glycidyl methacrylate, allyl glycidyl ether, methallyl glycidyl ether. More preferably the compound containing a carbon-carbon double bond comprises acryloyl chloride.

The reactions that may be implemented for this functionalization are alkylation, esterification, amidation, transesterification, or transamidation.

The Heat-Sensitive Copolymer

Another aspect of the invention relates to a heat-sensitive copolymer comprising:
95 mol % to 99.99999 mol % of at least one water-soluble monomer and,
10⁻⁵ mol % to 5 mol % of at least an LCST macromonomer of formula (I) as described above.

The heat-sensitive copolymer comprises at least one water-soluble monomer and at least one macromonomer of formula (I). In other words, the heat-sensitive copolymer is a copolymer of at least one of each of these two types of monomers.

The heat-sensitive copolymer is obtained by polymerization of said at least one water-soluble monomer and at least one LCST macromonomer of formula (I), in the molar proportions mentioned above.

The term “polymer comprising at least one monomer” is understood to mean a polymer obtained from several molecules of at least one monomer. Thus, a polymer of a monomer corresponds to a polymer obtained from several repeating units of molecules of a monomer.

In this text, the term “water-soluble” designates a compound (in particular a monomer) forming an aqueous solution without insoluble particles when it is added under stirring for 4 hours at 25° C. at a concentration of 20 gL⁻¹ in the deionized water.

Preferably, the copolymer comprises between 1.10⁻⁵ and 5 mol % of the LCST macromonomer of formula (I), preferably between 1.10-4 and 2 mol % relative to the total number of monomers of the copolymer.

Typically, the water-soluble monomer may be selected from the group comprising nonionic monomers, anionic monomers, cationic monomers, and mixtures of nonionic monomers and anionic monomers.

The water-soluble monomer may be a non-ionic monomer which may in particular be chosen from the group comprising water-soluble vinyl monomers, and in particular, acrylamide; N-isopropylacrylamide; N,N-dimethylacrylamide; N-vinylformamide; acryloyl morpholine; N,N-diethyl acrylamide; N-tert-butyl acrylamide; N-vinylpyrrolidone; N-vinyl caprolactam; and diacetone acrylamide. Advantageously, the nonionic monomer is acrylamide.

According to a particular embodiment, the copolymer comprises between 0 and 99.99999 mol % of nonionic monomer(s).

The water-soluble monomer may also be an anionic monomer. Advantageously, the other anionic monomer(s) that may be used within the scope of the invention may be chosen from a large group. These monomers may have acrylic, vinyl, maleic, fumaric, malonic, itaconic, or allylic functions and contain a carboxylate, phosphonate, phosphate, sulfate, sulfonate group, or another group with an anionic charge.

The anionic monomer may be in the acid form or else in the form of an alkaline-earth metal or alkali metal salt. Examples of suitable monomers include acrylic acid; methacrylic acid; itaconic acid; crotonic acid; maleic acid; fumaric acid; monomers of strong acid type having, for example, a function of the sulfonic acid or phosphonic acid type, such as 2-acrylamido-2-methylpropane sulfonic acid, vinyl sulfonic acid, vinylphosphonic acid, allyl sulfonic acid, allyl phosphonic acid, styrene sulfonic acid, 2-acrylamido-2-methylpropane sulfonic acid; and the water-soluble salts of these monomers such as their alkali metal, alkaline earth metal, or ammonium salts. Advantageously, the anionic monomer is 2-acrylamido-2-methylpropane sulfonic acid or acrylic acid.

According to a particular embodiment, the copolymer comprises between 0 and 99.9999 mol % of anionic monomer(s).

The water-soluble monomer may optionally be a cationic monomer of the acrylamide, acrylic, vinyl, allylic, or maleic type possessing an amine or quaternary ammonium function. In particular and in a non-limitative way, we may mention quaternized or salified dimethylaminoethyl acrylate (ADAME), and dimethylaminoethyl methacrylate (MADAME), dimethyldiallylammonium chloride (DADMAC), acrylamido propyltrimethyl ammonium chloride (APTAC) and methacrylamido propyltrimethyl ammonium chloride (MAPTAC). Preferably, the cationic monomer is dimethylaminoethyl methacrylate (MADAME).

According to a particular embodiment, the heat-sensitive copolymer comprises between 0 and 99.99999 mol % of cationic monomer(s),

The polymer according to the invention may be post-hydrolyzed. In a manner known per se, a branched polymer is a polymer that has branches, moieties, or branches on the main chain, generally arranged in a plane. The branching may preferably be conducted during (or optionally after) the polymerization, in the presence of a branching/crosslinking agent and optionally of a transfer agent. The transfer agent is preferably chosen from ethylene bisacrylamide (MBA), ethylene glycol di-acrylate, polyethylene glycol dimethacrylate, diacrylamide, cyanomethylacrylate, vinyloxyethylacrylate, or methacrylate, triallylamine, tetraallylammonium chloride, formaldehyde, glyoxal, compounds of the glycidyl ether type such as ethylene glycol diglycidyl ether, or epoxies or any other means well known to those skilled in the art allowing crosslinking.

In general, the heat-sensitive copolymer does not require any particular polymerization technique for its preparation. Indeed, it may be obtained according to all the polymerization techniques well known to those skilled in the art.

This may include the use of free radicals, such as free radical polymerization using UV, azo, redox, or thermal initiators, as well as controlled radical polymerization known as RAFT (Reversible-Addition Fragmentation chain Transfer), NMP (Nitroxide Mediated Polymerization), or ATRP (Atom Transfer Radical Polymerization).

In general, the water-soluble polymer does not require the development of a particular polymerization process. Indeed, it may be obtained according to all the polymerization methods well known to the person skilled in the art.

These may include solution polymerization; gel polymerization; precipitation polymerization; emulsion polymerization (aqueous or inverse); suspension polymerization; or micellar polymerization.

The heat-sensitive copolymer may be in liquid, gel, or solid form when its preparation includes a drying step such as spray drying, drum drying, microwave drying, or even fluidized bed drying. Advantageously, the heat-sensitive copolymer has a molecular weight of between 100,000 and 25,000,000 g/mol, preferably between 250,000 and 20,000,000 g/mol, and even more preferably between 500,000 and 15,000,000 g/mol.

The LCST groups of the heat-sensitive copolymer have a heating transition temperature of 0 to 140° C. at a weight concentration in deionized water of 1% by weight of said LCST groups.

The heat-sensitive copolymer has, for a given mass concentration in an aqueous solution and above a given critical temperature, viscosification properties, also referred to as viscosifying properties or thermo-viscosifying properties.

These properties of viscosification by heating observed beyond the transition temperature of the LCST chains are due to the chain association, which have become insoluble, with each other, in order to limit the exposure to water of the LCST patterns.

These viscosifying properties are observed beyond the transition temperature and when the polymer concentration in solution is sufficient to allow intermolecular interactions between LCST groups carried by chains of different copolymers. The minimum concentration required, called the Critical Aggregation Concentration (CAC), is assessed by rheology measurements. It corresponds to the concentration from which the viscosity of an aqueous solution of heat-sensitive copolymer becomes greater than the viscosity of a solution of the equivalent polymer not comprising any LCST groups. Another aspect of the invention relates to the use of these heat-sensitive (co)polymers. More specifically, the invention relates to the use of these (co)polymers in the oil and gas industry, hydraulic fracturing, paper, water treatment, construction, mining, cosmetics, textiles, detergents, or civil engineering. Preferably, the (co)polymers are used in the field of oil and/or gas well development such as enhanced oil and gas recovery, conformation, acid treatments, or hydraulic fracturing. More specifically, the invention also relates to a method of operating an oil and/or gas wells, in particular for enhanced oil and/or gas recovery, conformance, acid treatments, or fracturing hydraulics, comprising at least the following steps:
preparation of an aqueous solution comprising at least one heat-sensitive (co)polymer previously described,
injection of the aqueous solution into the oil and/or gas well.

Another aspect of the invention relates to a method for drilling wells in an underground formation comprising a step of evacuating the drilling cuttings by means of a drilling fluid comprising at least one previously described heat-sensitive (co)polymer.

The preparation of heat-sensitive polymers is part of a general principle to improve the performance of products and more particularly to improve the thickening power. Reducing the quantity of product required for application therefore implicitly contributes to the reduction of greenhouse gas emissions such as CO₂.

The invention and the advantages thereof will become clearer from the following examples given to illustrate the invention and not in a limitative manner.

### DESCRIPTION OF THE FIGURES

The figures below illustrate, in a non-limitative manner, the advantages and characteristics of the invention:

FIG. 1 is a graph that plots viscosity versus temperature for a P1 polymer solution at pH=1 and pH=8.

FIG. 2 is a graph that plots viscosity versus temperature for a P2 polymer solution.

### EXAMPLES OF EMBODIMENTS OF THE INVENTION

### 1/Synthesis of the T1 Telomere

To make a telomere called T1, the following process is performed.

In a jacketed reactor:
Deionized water (410 g), and 2-acrylamido-2-methylpropane sulfonic acid (ATBS, 48.3 g, i.e., 0.21 mol), tert-butyl acrylamide (TBA, 6.7 g, or 0.05 mol) and diethylacrylamide (DEA, 114 g, or 0.89 mol) are added.
The mixture is stirred.
The pH of the mixture is adjusted between 4.0 and 5.0 using a solution of 40% NaOH by weight in water.
The mixture obtained is heated to 50° C.
It is deoxygenated with a nitrogen sparge for 40 minutes.
Aminoethanethiol HCl (2.5 g) is added.
2,2′-azobis(2-methylpropionamidine) dihydrochloride (0.22 g) is added to initiate telomerization.
After stabilization of the temperature, the mixture is stirred for 2 hours and then cooled to 25° C.

The telomere obtained is of formula (VI):

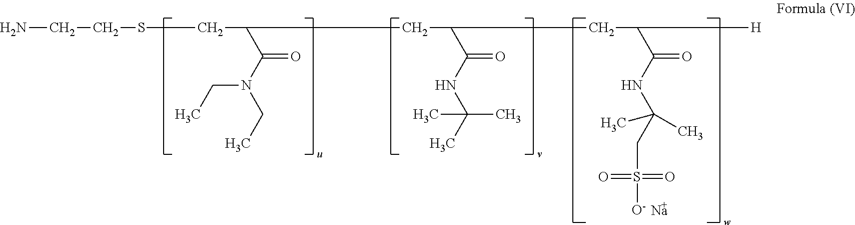

Wherein u=85 mol %, v=5 mol %, and w=10 mol %, relative to the total number of moles of the three monomers.

### 2/Synthesis of Macromonomer M1

To make a macromonomer called M1, the following method is performed.

In a jacketed reactor:
we add 400 g of the T1 telomer solution at 23% by weight in water.
The solution is stirred.
The pH is adjusted to 7.5 using a solution of 40% NaOH by weight in water.
It is cooled to 5° C.
Using a burette, 1.5 g of acryloyl chloride is added drop by drop.
The pH is continuously adjusted between 7 and 9 using a solution of 40% NaOH by weight in water.
The temperature is maintained at 5° C. throughout the reaction.
The mixture is stirred for 2 hours after the end of the reaction while continuing to check the pH.

A concentrated viscous solution containing 25% by weight of macromonomer M1 of formula (VII) is obtained.

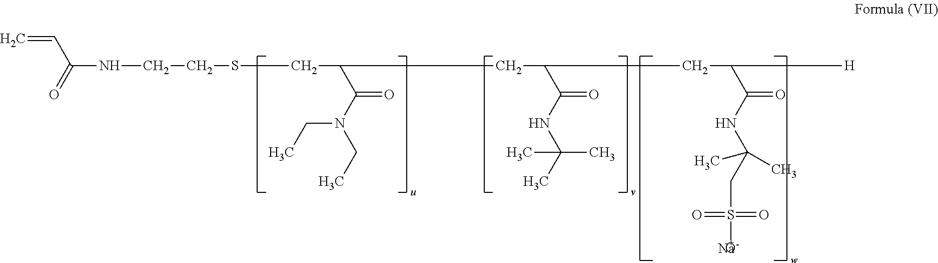

Of course, u, v, and w, remain unchanged and are thus such that u=85 mol %, v=5 mol %, and w=10 mol %, relative to the total number of moles of the three monomers.

### 3/Synthesis of the Heat-Sensitive Copolymer in the P1 Solution

The heat-sensitive copolymer is prepared by radical polymerization.

Into a 1 liter adiabatic reactor:
189 g of dimethylaminoethyl methacrylate (MADAME) solution at 100% by weight in water, 290 g of macromonomer M1 solution at 25% by weight in water, and 20 g of water are added.
The solution is stirred.
It is deoxygenated with a nitrogen sparge for 30 minutes.
Polymerization is initiated at low temperature with Mohr's salt oxidizing-reducing couple—sodium persulfate and does not exceed 30° C.
A P1 polymer is obtained.

### 4/Viscosity Test of a P1 Polymer

An aqueous solution of P1 polymer at 1% by weight is prepared in deionized water at pH=8 adjusted using a solution of NaOH 40% by weight in water, and a solution of P1 polymer whose pH was lowered to 1 using a concentrated acid solution.

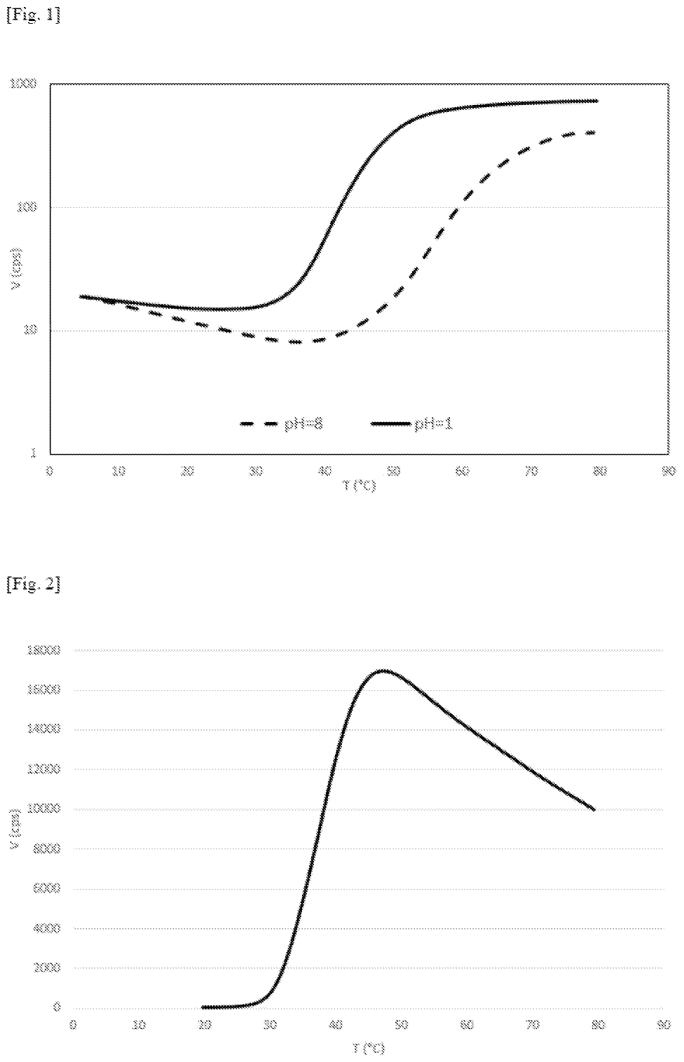

The viscosity of the 2 solutions is measured with a rheometer (cone-plane module 6 cm, angle 2°) with a shear at 10 s⁻¹ according to a temperature ramp ranging from 5 to 80° C. In this way, we obtain the graph in FIG. 1.

On this graph, we observe that the aqueous solution has an increase in viscosity V (cps) with the temperature T (° C.), until reaching a maximum threshold around 80° C. of about 900 centipoises (cps) for the solution at pH=1 and about 650 cps for the solution at pH=8.

The presence of gel particles is evaluated by passing the copolymer solution through a 200 μm filter and observing the number of gel points on the filter.

For the aqueous solution of a P1 polymer, we note the absence of gel particles.

### 5/Synthesis of a P2 Polymer in Solution

The copolymer is prepared by radical polymerization.

In a 1 liter adiabatic reactor:
78 g of acrylamide (AM) solution at 50% by weight in water, 109 g of 2-acrylamido-2-methylpropane sulfonic acid (ATBS) at 50%, 237.6 g of a solution of macromonomer M1 at 25% by weight in water and 574 g of water are added. The transfer agent is added.
The solution is stirred.
It is deoxygenated with a nitrogen sparge for 30 minutes.
Polymerization is initiated at low temperature with an oxidizing-reducing couple Mohr's salt—sodium persulfate and does not exceed 30° C.
A P2 polymer is obtained.

### 6/P2 Polymer Viscosity Test

An aqueous solution of a P2 polymer at 4% by weight in a brine comprising 60 g/l of NaCl is prepared.

The viscosity of the 2 solutions is measured with a rheometer (cone-plane module 6 cm, angle 2°) with a shear at 7 s⁻¹ according to a temperature ramp ranging from 20 to 80° C. In this way, we obtain the graph in FIG. 2.

On this graph, it is observed that the aqueous solution exhibits an increase in viscosity V (cps) with the temperature T(° C.), until reaching a maximum threshold around 45° C. of about 17,000 cps. Above this threshold, the viscosity decreases.

By repeating the previously described protocol, we note the absence of gel particles for the aqueous P2 polymer solution.

Thus, these examples show that the copolymer of the invention has a significant and satisfactory thickening power for use as a thickening agent, and also has the advantage of being free of gel particles during its use.

1. A Lower Critical Solution Temperature (“LCST” macromonomer of formula (I): 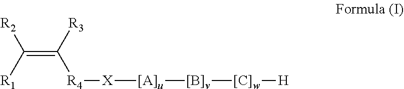
wherein,
R₁, R₂, and R₃ are independently hydrogen, methyl group, C(═O)—YR₅, CH₂C(═O)—YR₅, C(═O)—O⁻M⁺, or CH₂C(═O)—O⁻M⁺;
Y is NR′₅ or O;
R₅, R′₅ are independently a hydrogen atom or a carbon radical, saturated or unsaturated, optionally aromatic, linear, branched or cyclic, comprising 1 to 30 carbon atoms, comprising from 0 to 4 heteroatoms chosen from the group comprising 0, N, and S;
R₄ is CH₂, C(═O), C₆H₄—C(CH₃)₂—NH—C(═O)— where C₆H₄ is a disubstituted benzene ring, C(═O)O—CH₂—CH(OH)—CH₂, or CH₂—O—CH₂—CH(OH)—CH₂;
M⁺ is an alkali metal cation, an alkaline earth metal cation, or an ammonium;
X is chosen from the groups of formula Z—R₈—S wherein Z is O, NH, O—C(═O), O—C(═O)—CH(NH₂) and R₈ is a CₙH₂ₙ group with integer n between 1 and 30,
monomer A is of formula (II): 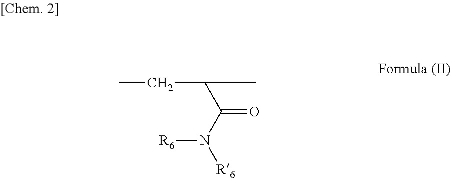
monomer B is of formula (III): 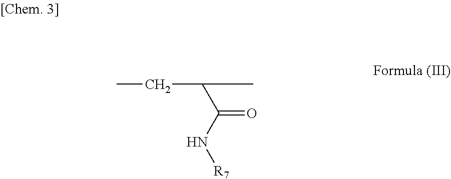
wherein,
R₆, R₆′, and R₇ are independently a carbon radical, saturated or unsaturated, optionally aromatic, linear, branched, or cyclic, comprising 1 to 30 carbon atoms, comprising from 0 to 4 heteroatoms chosen from the group comprising O, N, and S;
monomer C is at least one anionic monomer and/or at least one cationic monomer and/or at least one nonionic monomer,
u, v, and w are the molar proportions of the monomers, such that u+v+w=100 mol %, and
u is between 50 and 99 mol %, preferably between 60 and 98 mol %, more preferably between 70 and 95 mol % relative to all of the molar proportions of monomers A, B, and C,
v is between 1 and 20 mol %, preferably between 1 and 15 mol %, more preferably between 2 and 10 mol % with respect to the total molar proportions of monomers A, B, and C,
w is between 0 and 30 mol %, preferably between 1 and 25 mol %, more preferably between 3 and 20 mol % with respect to the total molar proportions of monomers A, B, and C.

2. The macromonomer of claim 1, wherein:
R₁, R₂, and R₃ independently are a hydrogen atom, or a methyl group;—
R₄ is CH₂, C(═O),C₆H₄—C(CH₃)₂—NH—C(═O)— where C₆H₄ is a disubstituted benzene ring, C(═O)O—CH₂—CH(OH)—CH₂ or CH₂—O—CH₂—CH(OH)—CH₂;
X is of the formula Z—R₈—S wherein Z is O or NH and R₈ is a CₙH₂ₙ group with n being an integer between 1 and 30;
R₆ and R₆′ are independently a carbon radical, saturated or unsaturated, comprising between 2 and 10 carbon atoms;
R₇ is a carbon radical, saturated or unsaturated, linear or branched comprising between 3 and 10 carbon atoms.

3. The macromonomer according to claim 1, wherein monomer C is an anionic monomer.

4. The macromonomer according to claim 1, wherein monomer C comprises at least one anionic monomer selected from acrylic acid, methacrylic acid, itaconic acid, crotonic acid, maleic acid, fumaric acid, 2-acrylamido 2-methylpropane sulfonic acid, vinylsulfonic acid, vinylphosphonic acid, allyl sulfonic acid, allyl phosphonic acid, styrene sulfonic acid; and the water-soluble salts of these monomers such as their alkali metal, alkaline earth metal, or ammonium salts.

5. The macromonomer according to claim 1, wherein:
R₁, R₂, and R₃ are independently a hydrogen atom or a methyl group;
R₄ is CH₂, C(═O), C₆H₄—C(CH₃)₂—NH—C(═O)— where C₆H₄ is a disubstituted benzene ring, C(═O)O—CH₂—CH(OH)—CH₂, or CH₂—O—CH₂—CH(OH)—CH₂;
X is of formula Z—R₈—S wherein Z is an O or NH and R₈ is a CₙH₂ₙ group with n being an integer between 1 and 18;
monomer C is 2-acrylamido-2-methylpropane sulfonic acid and/or its alkali metal, alkaline-earth metal, or ammonium salt;
R₆ and R₆′ are the —CH₂—CH₃ group;
R₇ is the —C(CH₃)₃ group.

6. The macromonomer according to claim 1, wherein monomer C is 2-acrylamido-2-methylpropane sulfonic acid and/or its alkali metal, alkaline-earth metal, or ammonium salt.

7. A method of preparing at least one LCST macromonomer according to claim 1 comprising:
the preparation of at least one LCST telomer from at least one A monomer of formula (II), at least one B monomer of formula (III), at least one C monomer, and a telogenic agent,
the preparation of a macromonomer by reaction between the LCST telomer obtained and a compound containing a carbon-carbon double bond, wherein the carbon-carbon double bond is always present in the LCST macromonomer obtained after said reaction.

8. The method of preparing at least one LCST macromonomer according to claim 7, wherein the telogenic agent is selected from compounds of the formula Z′—R₈—SH wherein Z′ is OH, NH₂, HO—C(═O)—CH—(NH₂) or C(═O)—OH, and R₈ is a CₙH₂ₙ group with n being an integer between 1 and 30.

9. The method of preparing at least one LCST macromonomer according to claim 7, wherein the telogenic agent is selected from compounds of formula Z′—R₈—SH wherein Z′ is OH or NH₂ and R₈ is a CₙH₂ₙ group with n being an integer between 1 and 30.

10. The method of preparing at least one LCST macromonomer according to claim 7, wherein the telogenic agent is selected from compounds of the formula Z′—R₁₀—SH wherein Z′ is OH or NH₂ and R₁₀ is a CₙH₂ₙ group with n being an integer between 1 and 18.

11. The method of preparing at least one LCST macromonomer according to claim 7, wherein the compound containing a carbon-carbon double bond is selected from acryloyl chloride, acrylic acid, methacryloyl chloride, methacrylic acid, maleic anhydride, methacrylic anhydride, aliphatic unsaturated isocyanates, allyl chloride, allyl bromide, glycidyl acrylate, glycidyl methacrylate, allyl glycidyl ether, and metallyl glycidyl ether.

12. A heat-sensitive copolymer, comprising:
95 mol % to 99.99999 mol % of at least one water-soluble monomer, and
10⁻⁵ mol % to 5 mol % of at least one LCST macromonomer according to claim 1.

13. The heat-sensitive copolymer according to claim 12, wherein the water-soluble monomer is chosen from nonionic monomers, anionic monomers, and/or cationic monomers.

14. The heat-sensitive copolymer according to claim 12, wherein the water-soluble monomer is a non-ionic monomer chosen from the group comprising water-soluble vinyl monomers, preferably acrylamide; N-isopropylacrylamide; N,N-dimethylacrylamide; N-vinylformamide; acryloyl morpholine; N,N-diethyl acrylamide; N-tert-butyl acrylamide; N-vinylpyrrolidone; N-vinyl caprolactam; and diacetone acrylamide.

15. The heat-sensitive copolymer of claim 12, wherein the water-soluble monomer is an anionic monomer selected from the group consisting of acrylic acid; acrylic acid; methacrylic acid; itaconic acid; crotonic acid; maleic acid; fumaric acid; monomers of strong acid type having, for example, a function of the sulfonic acid or phosphonic acid type, such as 2-acrylamido-2-methylpropane sulfonic acid, vinyl sulfonic acid, vinylphosphonic acid, allyl sulfonic acid, allyl phosphonic acid, styrene sulfonic acid, 2-acrylamido-2-methylpropane sulfonic acid; and the water-soluble salts of these monomers such as their alkali metal, alkaline earth metal, or ammonium salts.

16. The heat-sensitive copolymer according to claim 12, wherein the water-soluble monomer is a cationic monomer chosen from the group comprising quaternized or salified dimethylaminoethyl acrylate (ADAME) and dimethylaminoethyl methacrylate (MADAME), dimethyldiallylammonium chloride (DADMAC), acrylamido propyltrimethyl ammonium chloride (APTAC) and methacrylamido propyltrimethyl ammonium chloride (MAPTAC).

17. The macromonomer according to claim 2, wherein monomer C is an anionic monomer.

18. The macromonomer according to claim 2, wherein monomer C comprises at least one anionic monomer selected from acrylic acid, methacrylic acid, itaconic acid, crotonic acid, maleic acid, fumaric acid, 2-acrylamido 2-methylpropane sulfonic acid, vinylsulfonic acid, vinylphosphonic acid, allyl sulfonic acid, allyl phosphonic acid, styrene sulfonic acid; and the water-soluble salts of these monomers such as their alkali metal, alkaline earth metal, or ammonium salts.

19. The macromonomer according to claim 18, wherein:
R₁, R₂, and R₃ are independently a hydrogen atom or a methyl group;
R₄ is CH₂, C(═O), C₆H₄—C(CH₃)₂—NH—C(═O)— where C₆H₄ is a disubstituted benzene ring, C(═O)O—CH₂—CH(OH)—CH₂, or CH₂—O—CH₂—CH(OH)—CH₂;
X is of formula Z—R₈—S wherein Z is an O or NH and R₈ is a CₙH₂ₙ group with n being an integer between 1 and 18;
monomer C is 2-acrylamido-2-methylpropane sulfonic acid and/or its alkali metal, alkaline-earth metal, or ammonium salt;
R₆ and R₆′ are the —CH₂—CH₃ group;
R₇ is the —C(CH₃)₃ group.

20. The macromonomer according to claim 2, wherein monomer C is 2-acrylamido-2-methylpropane sulfonic acid and/or its alkali metal, alkaline-earth metal, or ammonium salt.
